(19) United States
(12) Patent Application Publication
(10) Pub. No.: US 2016/0029563 A1
(43) Pub. Date: Feb. 4, 2016

(54) WRAPPING DEVICE AND METHOD OF OPERATION THEREOF

(71) Applicant: GROUPE ANDERSON INC., Chesterville (CA)

(72) Inventors: Frederic LAVOIE, Chesterville (CA); Luc D'AMOURS, St-Norbert-d'Arthabaska (CA); Patrice DESROCHERS, St-Christophe-d'Arthabaska (CA)

(21) Appl. No.: 14/777,213

(22) PCT Filed: Mar. 14, 2014
(86) PCT No.: PCT/CA2014/050253

§ 371 Date: Sep. 15, 2015

Related U.S. Application Data
(60) Provisional application No. 61/789,434, filed on Mar. 15, 2013.

(51) Int. Cl. A01F 15/07; B65B 59/00; B65B 11/58; B65B 11/04

(52) U.S. Cl. CPC A01F 15/071; B65B 11/04; B65B 59/00; B65B 11/58; A01F 2015/0725

(57) ABSTRACT

An inline bale wrapping device is for wrapping at least one bale. The wrapping device includes a base frame defining a bale wrapping section between a bale receiving section and a bale discharging section. The wrapping device also includes a moving mechanism configured to move the at least one bale longitudinally along a longitudinal moving axis, an end surface wrapping mechanism configured to dispense and maintain a length of end surface film across the longitudinal moving axis and a side surface wrapping mechanism mounted between the end surface wrapping mechanism and the bale discharging section and configured to wrap a length of side surface film around at least a longitudinal portion of the side surface of the bale, over a portion of the length of end surface film. A method of operation of the inline bale wrapping device is for wrapping at least one bale.

### FIELD OF THE INVENTION

The present invention relates to the field of wrapping devices. More specifically, the present invention relates to an inline bale wrapping device configured for sealing an end surface of at least one bale and to a method of operation thereof.

### BACKGROUND

It is known in the art to use wrapping devices, such as inline wrappers for wrapping bales of silage. However, known inline wrappers are usually used to dispense wrapping film solely around a side surface of a bale or a group of bales, and therefore cannot perform a sealing of an end surface thereof. Therefore, it is known to cover the end surface of a bale or a group of bales, prior to a wrapping of the side surface, by the inline bale wrapping device, for example, by inserting a bale with the end surface to be sealed in a bag, such as to cover the end surface. Subsequently, the wrapping of the side surface is performed, using known inline wrapping devices. Such an operation is however time consuming and requires many manipulations by a user, which is undesirable.

Moreover, individual bale wrappers are also known in the art for individually wrapping bales of silage. Such wrapping devices commonly include means for rotating a bale about a first axis and means for providing wrapping around the bale about a second axis, substantially perpendicular to the first axis, such as to wrap the entire outer surface of a bale, including the end surfaces and the side surface thereof.

In the field of individual wrappers, United States Patent Application No. 2008/0264031, describes an apparatus for forming and wrapping a bale. The apparatus described includes a first dispenser adapted for holding a roll of wrapping material such that it engages the circumferential surface of the bale, around approximately 180°, as the bale is being transferred from a bale forming chamber to bale supporting rollers. The document mentions that the wrapping material is sized such that opposite side edges of the wrapping material embrace the axial opposite ends (end surfaces) of the bale, adjacent to the corner edges. The bale supporting rollers are rotatable, in order to rotate the bale about a first longitudinal axis and a second dispenser is provided to revolve about a second wrapping axis, substantially perpendicular to the first axis, to secure the wrapping material from the first dispenser which extends partially around the circumferential surface of the bale, after the bale has been transferred from the bale forming chamber to bale supporting rollers, and prior to the rotation of the bale. Subsequently, the bale can be wrapped longitudinally, about the second axis, as the bale is rotated and the circumferential surface is wrapped using the wrapping material from the first dispenser. Such a configuration is designed to increase the amount of wrapping layers at the corner edges of the bale.

Individual wrappers however tend to suffer from several drawbacks. For example and without being limitative, such wrappers do not allow the wrapping of more than one bale together, i.e. the sealing of the end surfaces of the bales at the opposed ends of a bale assembly including more than one bale, theses apparatus being designed for the wrapping of each bale individually. Moreover, such individual wrappers tend to use a large quantity of wrapping material in the wrapping of each bale, which can be undesirable.

In view of the above, there is a need for an improved wrapping device and method, which would be able to overcome, or at least minimize, some of the above-discussed prior art concerns.

### SUMMARY OF THE INVENTION

According to a first general aspect, there is provided an inline bale wrapping device for wrapping at least one bale having an end surface and a side surface. The wrapping device comprises a base frame defining a bale receiving section, a bale discharging section and a bale wrapping section. The bale wrapping section is positioned between the bale receiving section and the bale discharging section of the base frame. The wrapping device also comprises a moving mechanism configured to move the at least one bale longitudinally along a longitudinal moving axis, between the bale receiving section and the bale discharging section of the base frame. The wrapping device further comprises an end surface wrapping mechanism connected to the base frame, in the bale wrapping section. The end surface wrapping mechanism is configured to dispense and maintain a length of end surface film across the longitudinal moving axis. The length of end surface film is sized and shaped to extend beyond a periphery of the end surface of the at least one bale. The wrapping device further comprises a side surface wrapping mechanism mounted to the base frame, in the bale wrapping section, between the end surface wrapping mechanism and the bale discharging section. The side surface wrapping mechanism is configured to dispense a length of side surface film and wrapping the length of side surface film around at least a longitudinal portion of the side surface of the bale, over a portion of the length of end surface film.

In an embodiment, the end surface wrapping mechanism comprises an end surface film source support, the end surface film source support being configurable in an operative configuration and a dispensing configuration.

In an embodiment, when the end surface film source support is configured in the operative configuration, the end surface film source support is positioned above the wrapping section of the base frame at a distance sufficient for the at least one bale to be moved between the frame and the end surface film source support.

In an embodiment, when the end surface film source support is configured in the dispensing configuration, the end surface film source support is positioned proximate to the base frame such as to be accessible to an operator standing on the ground.

In an embodiment, the end surface film source support is mounted to pivoting arms. The pivoting arms are pivotally mounted to the frame and are configured to shift the end surface film source support between the operative configuration and the dispensing configuration upon pivoting thereof.

In an embodiment, the inline bale wrapping device further comprises at least one end surface film guide configured to guide a section of the length of end surface film towards the side surface of the bale.

In an embodiment, the at least one end surface film guide comprises an upper arch configured to guide a section of the length of end surface film towards the side surface of the bale, from above.

In an embodiment, the at least one end surface film guide comprises at least one lateral guide positioned laterally along the longitudinal moving axis and configured to guide a section of the end surface film towards the side surface of the bale laterally.

In an embodiment, the side wrapping cutting mechanism comprises at least one cutting assembly with a resilient member and a blade; and at least one corresponding extendable arm having an abutment member at a first end thereof and being configurable between an extended configuration where the first end is spaced apart from the corresponding cutting assembly, and a retracted configuration, where the abutment member is pressed against the resilient member of the corresponding cutting assembly.

According to another general aspect, there is also provided a method for wrapping an end surface and at least a portion of a side surface of at least one bale using an inline bale wrapping device. The method comprises the steps of: receiving at least one bale in a receiving section of the bale wrapping device, the at least one base being movable longitudinally along a transfer path following a longitudinal axis; dispensing and maintaining a length of end surface film across the transfer path, the length of end surface film being sized and shaped to extend beyond a periphery of the end surface of the at least one bale; moving the at least one bale longitudinally along the transfer path such as to engage the end surface of the at least one bale with the end surface film; and wrapping a side surface film around a side surface of the at least one bale, over a portion of the end surface film extending beyond the periphery of the end surface of the at least one bale.

In an embodiment, the step of dispensing and maintaining a length of end surface film across the transfer path includes the steps of: configuring an end surface film source support in a dispensing configuration; pulling a length of end surface film from an end surface film source and engaging the end surface film to at least one attachment member; and configuring the end surface film source support in an operative configuration.

In an embodiment, the method further comprises the step of severing the end surface film and the side surface film.

In an embodiment, the method further comprises the step of cutting and holding a side surface film having a width, using at least one extendable arm with an abutment member at a first end and a corresponding cutting assembly with a resilient member and a blade.

In an embodiment, the step of cutting and holding a side surface film comprises the steps of: extending the at least one extendable arm proximate to the side surface of the bale, the at least one extendable arm spanning at least the width of the side surface film; dispensing an additional length of side surface film around the side surface of the at least one bale, the additional length extending over the at least one extendable arm; retracting the at least one extendable arm towards the corresponding cutting assembly, the retraction of the extendable arm causing a section of the side surface film to be held between the abutment member and the resilient member and another section of the side surface film to be severed against the blade.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a perspective view of a wrapping device with an end surface wrapping mechanism and a side surface wrapping mechanism according to an embodiment.

FIG. 2 is a side elevation view of the wrapping device of FIG. 1.

FIG. 3 is a perspective view of the wrapping device of FIG. 1 shown in combination with a bale in the receiving section and an end surface wrapping film shown across the wrapping section.

FIG. 4 is another perspective view of the wrapping device of FIG. 1 shown in combination with a bale in the bale receiving section and wrapped with an end surface wrapping film and a side surface wrapping film.

FIG. 5 is a close-up perspective view of a portion of the end surface wrapping mechanism, according to an embodiment, and shown in an operative configuration with an end surface film roll mounted thereon.

FIG. 6 is a close-up perspective view of a portion of a wrapping device with the end surface wrapping mechanism and the side surface wrapping mechanism according to an embodiment wherein the end surface wrapping mechanism is shown in a dispensing configuration.

FIG. 7 is a close-up perspective view of a first end of an end surface wrapping film source support of the end surface wrapping mechanism, according to an embodiment.

FIG. 8 is a close-up perspective view of a second end of an end surface wrapping film source support of the end surface wrapping mechanism, according to an embodiment.

FIG. 9 is a top perspective view of a wrapping device with a side wrapping cutting mechanism, according to an embodiment, cutting arms of the side wrapping cutting mechanism being shown in an extended configuration.

FIG. 10 is a close up perspective view of an extendable arm and a cutting assembly of a side wrapping cutting mechanism, according to an embodiment, the cutting arm of the side wrapping cutting mechanism being shown in an extended configuration.

FIG. 11 is another close up perspective view of a cutting arm and a cutting assembly of the side wrapping cutting mechanism, according to an embodiment, the cutting arm of the side wrapping cutting mechanism being shown in a retracted configuration.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the wrapping device and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the wrapping device, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

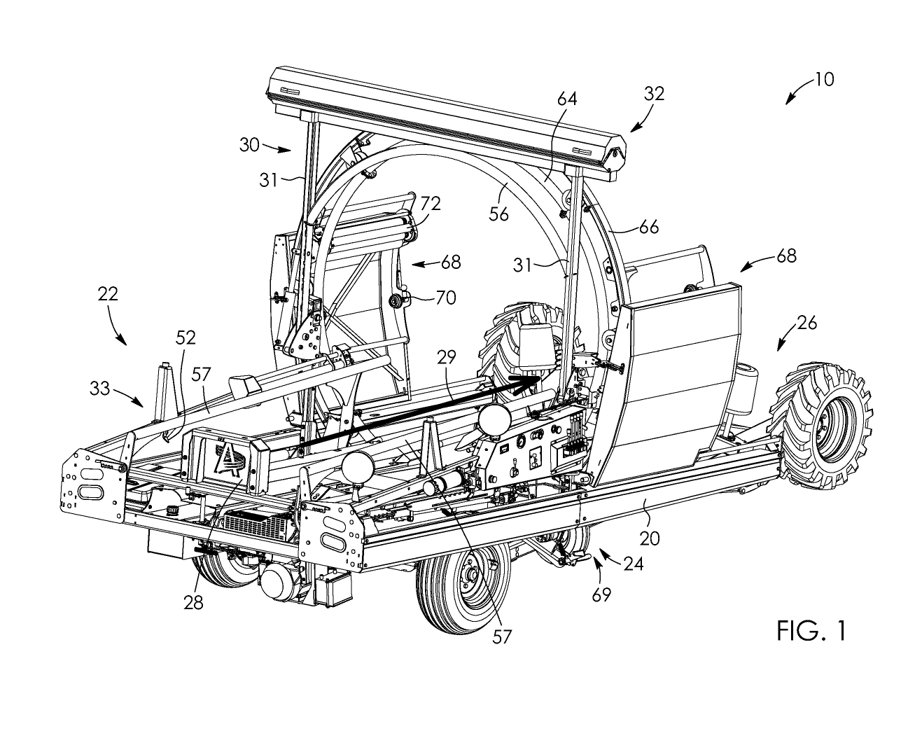

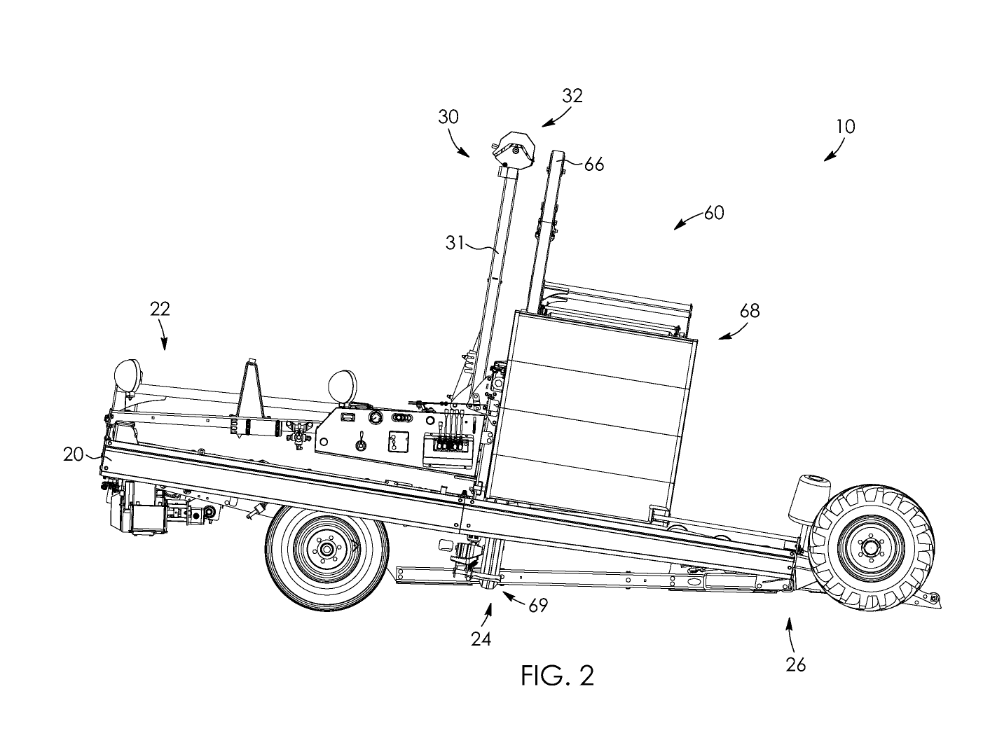

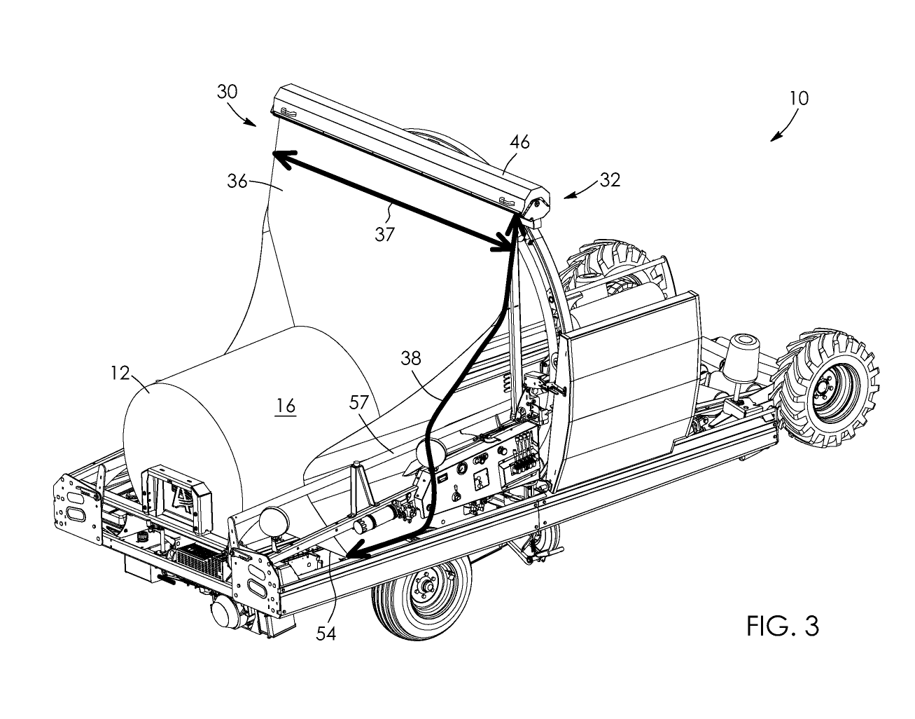

Referring generally to FIGS. 1 to 4, in accordance with one embodiment, there is provided an inline wrapping device 10 for wrapping at least one bale 12. The inline wrapping device 10 is configured such that it allows the wrapping of an end surface 14 of the at least one bale 12 as well as at least a longitudinal portion of the side surface 16 of the at least one bale 12. In the illustrated embodiment, the wrapping device 10 is an inline wrapper wherein the at least one bale 12 is moved longitudinally along a base frame 20 of the wrapping device 10, between a bale receiving section 22 and a bale discharging section 26. The wrapping (sealing) of the end surface 14 of the bale 12 as well as the longitudinal portion of the side surface 16 of the bale 12 occurs in a wrapping section 24 positioned between the bale receiving section 22 and a bale discharging section 26.

One skilled in the art will understand that, even though the wrapping device 10 is described herein as a device for wrapping at least one bale 12, in an embodiment, the device may be used for wrapping other types of loads differing from bales of silage. Moreover, it will be understood that the wrapping device 10 may also be used for wrapping bales being sized and shaped differently from the bales shown in the appended figures. For example and without being !imitative, the bales 12 could be square, rectangular or the like. It will also be understood that the wrapping device 10 may be used to wrap a single bale 12, and/or a bale assembly including more than one bale 12. In an embodiment (not shown) where the wrapping device 10 is used to wrap a bale assembly including more than one bale 12, the wrapping device 10 operates to wrap an end surface 14 and at least a section of a side surface 16 of the bale assembly in a similar manner used to wrap the end surface 14 and at least a section of the side surface 16 of a single bale 12, as described below, the difference being focused on the length of the side surface 16 of the bale assembly as opposed to the length of the side surface 16 of a single bale 12. For the sake of clarity, the description below will now only refer to a single bale 12 to describe the wrapping device 10 and the method of operation thereof.

In an embodiment, for moving the bale 12 between the different sections of the frame 20, a moving mechanism 28 is provided. In the illustrated embodiment, the moving mechanism 28 is a hydraulic ram positioned in the bale receiving section 22, and which pushes the bale 12 longitudinally from the bale receiving section 22 onto the bale wrapping section 24. In such an embodiment, movement of a bale 12, along a transfer path following a longitudinal moving axis 29, between the wrapping section 24 and the discharging section 26, occurs as a result of the bale 12 being pushed towards the discharging section 26 by a new bale being inserted in the bale wrapping section 24, through the action of the moving mechanism 28. One skilled in the art would however understand that, in an alternative embodiment, a moving mechanism 28 operating differently than the one described above could be used for moving the bale 12 between the different sections of the frame 20. Moreover, in an embodiment (not shown), the bale may be pushed manually longitudinally by an operator, the moving mechanism thereby only being configured to favor easy displacement of the bale between the different sections, for example and without being !imitative, by providing rollers for allowing the bale to be rolled longitudinally between the sections.

Still referring to FIGS. 1 to 4, in order to perform the wrapping of an end surface 14 of the bale 12 and at least a longitudinal portion of the side surface 16 of the bale 12, in an embodiment, the wrapping device 10 includes an end surface wrapping mechanism 30 and a side surface wrapping mechanism 60. Each one of the end surface wrapping mechanism 30 and the side surface wrapping mechanism 60 is mounted to the base frame 20, in the bale wrapping section 24 thereof.

In an embodiment, the end surface wrapping mechanism 30 includes an end surface film source support 32 into which an end surface film source 40 can be mounted and from which a length 38 of end surface film 36 can be dispensed, as well as a retaining assembly 33 configured to maintain at least a portion of the length 38 of end surface film 36 across the bale wrapping section 24. In an embodiment, the end surface film 36 is maintained across the bale wrapping section 24 with a sufficient tension such as to be held tightly against the end surface 14 of the bale, upon engagement therebetween.

In the course of the present application, the expression “across the bale wrapping section” is understood to mean that the film extends substantially perpendicularly to the longitudinal moving axis 29, in the wrapping section 24. In other words, the end surface film 36 extends substantially vertically such as to engage a bale traveling longitudinally along the travel path, through the wrapping section.

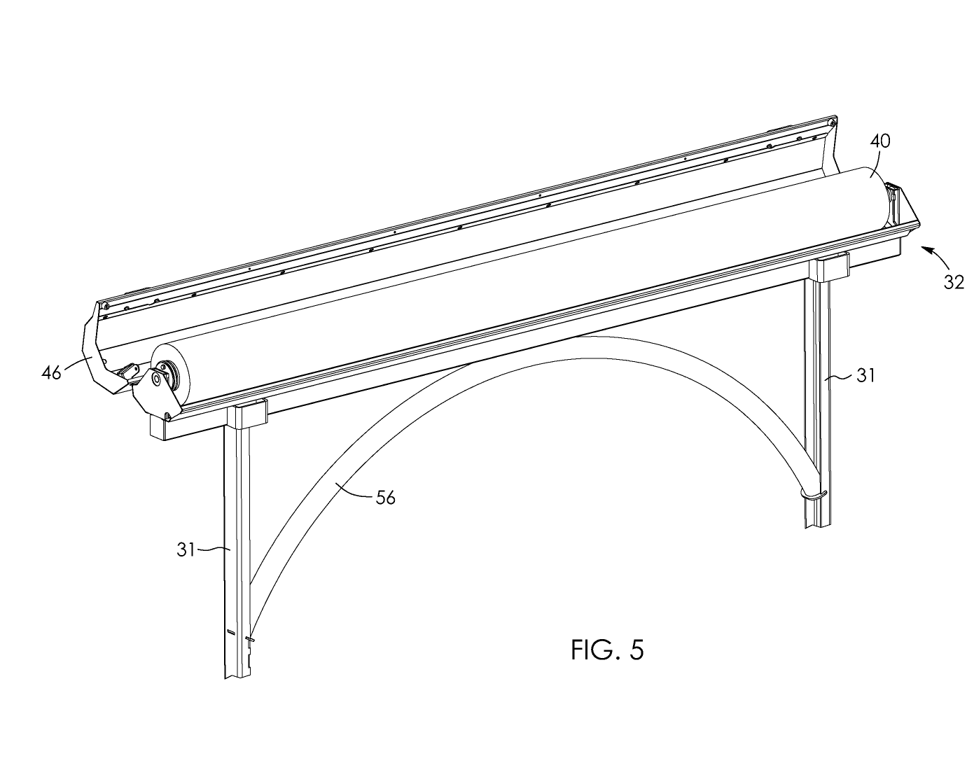

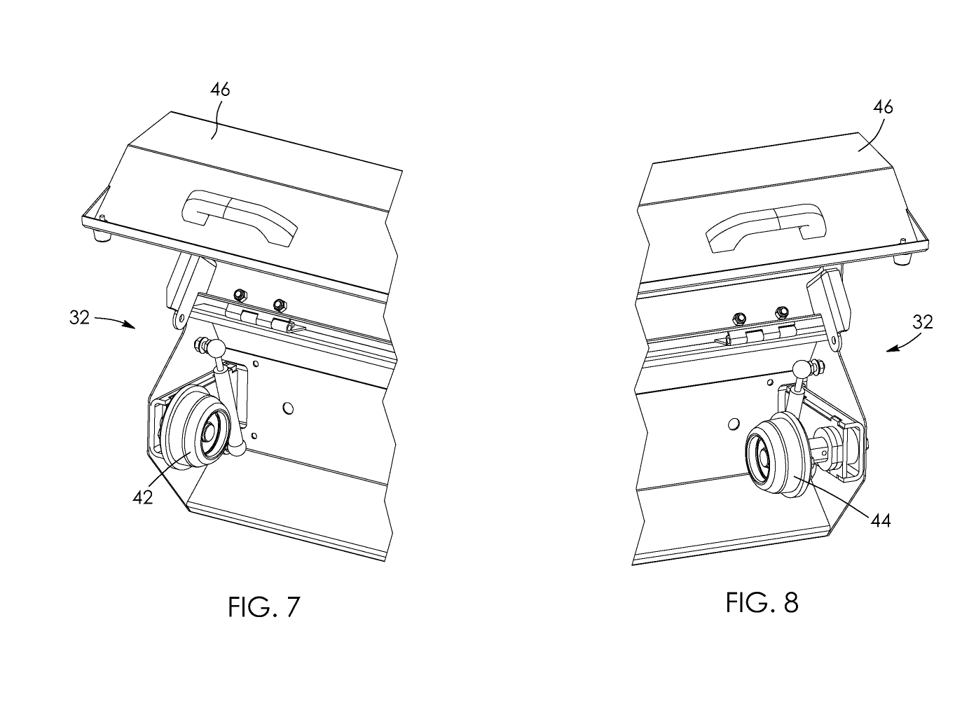

Referring to FIGS. 5, 7 and 8, in an embodiment, the end surface film source support 32 has a first connector 42 at a first end and a second connector 44 at a second end to engage and maintain the end surface film source 40. In the illustrated embodiment, the first connector 42 and second connector 44 are receiving cylinders sized and shaped for receiving the central bore of a roll of end surface film 36. The second connector 44 includes a biasing assembly (not shown) in order to allow the second connector 44 to be retracted in order to insert or retrieve a roll of end surface film 36 between the first connector 42 and the second connector 44 and subsequently bias the second connector towards the first connector such that the roll of end surface film 36 is firmly maintained therebetween. In operation, the friction between the inner surface of a roll of end surface film 36 and the first connector 42 and second connector 44, when the roll of end surface film 36 rotates thereabout, results in a tension being imparted and maintained in the end surface film 36 being dispensed.

One skilled in the art will understand that, in alternative embodiments (not shown), other components or configurations could be used to maintain a tension in the end surface film 36. For example and without being !imitative, in an embodiment, the first connector 42 and second connector 44 could be rotatable cylinders, rotating along with a roll of end surface film 36 mounted therebetween. In such an embodiment, the first connector 42 and second connector 44 may be configured not to freely rotate, i.e. a frictional force impeding the free rotation thereof, in order to maintain a tension in the end surface film 36. In another alternative embodiment (not shown), a tensioning mechanism may also be provided to maintain a tension in the end surface film 36.

One skilled in the art will understand that, in alternative embodiments, other components or assembly, differing from the one described above, for securing an end surface film source 40 to the end surface film source support 32 could also be used. For example and without being limitative, in an alternative embodiment, the first connector may be a receiving cylinder sized and shaped for receiving the central bore of a roll of rolled film, mounted to a pivoting member, pivotable about a hinge and lockable in place using a locking member. The second connector may be a locking connector composed of complementary bevelled cylinders engaged to one another such that the diameter of the second connector increases when the bevelled cylinders are pressed toward one another, for lockingly engaging the central bore of the roll of rolled film. A locking handle may be operatively connected to the second connector for varying the diameter of the second connector. Therefore, when a new roll of end surface film is received in the end surface film source support, the locking handle 45 can be used to secure the roll thereon, by increasing the diameter of the second connector, such that the second connector is engaged with the central bore of a roll of rolled film in a press fit. Opposite action can be taken to release an empty roll therefrom.

In an embodiment, a cover 46 is further provided to protect the end surface film source 40 mounted to the end surface wrapping film source support 32. The cover 46 may be pivotally mounted to allow easy covering/uncovering of the end surface film source 40 in the end surface wrapping film source support 32.

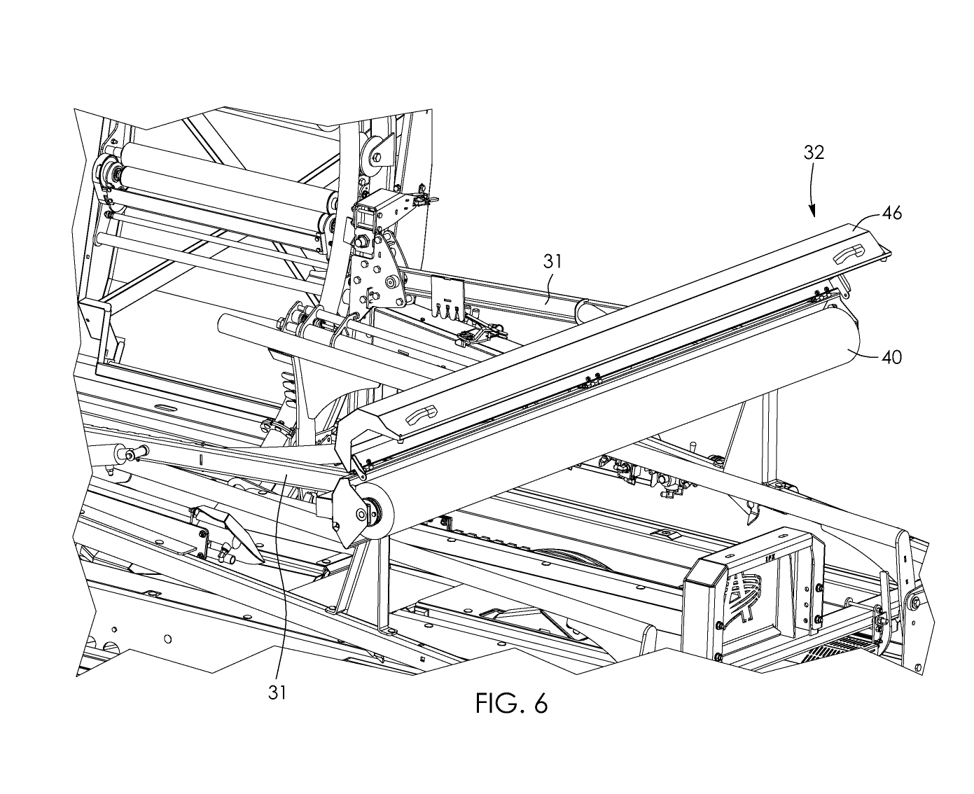

As can be seen more clearly in FIGS. 1 to 6, in an embodiment, the end surface film source support 32 of the end surface wrapping mechanism 30 is configurable in an operative configuration (as shown in FIGS. 1 to 5) and in a dispending configuration (as shown in FIG. 6).

In the operative configuration, the end surface film source support 32 is positioned above the wrapping section 24, at a distance sufficient for the bale 12 to be moved between the frame and the end surface film source support 32. In the operative configuration, the end surface film 36 extends downwardly from the end surface film source 40 contained in the end surface film source support 32, across the wrapping section 24. Such a configuration allows an end surface 14 of the bale 12 to contact and engage the end surface film 36, as it is moved along the longitudinal moving axis 29, into the wrapping section 24.

In the dispensing configuration, the end surface film source support 32 is lowered towards the base frame 20, such that the end surface film source 40 is easily accessible to an operator of the wrapping device 10. Therefore, when the end surface film source support 32 is positioned in the dispensing configuration, the operator of the wrapping device 10 can access the end surface film source 40, while standing on the ground, in order to pull a distal end 54 of the end surface film 36 therefrom and connect the distal end 54 of the end surface film 36 with the retaining assembly 33. It will be understood that, in an embodiment, the dispensing configuration can also be used to mount/dismount an end surface film source 40 onto the end surface film source support 32, for example in order to replace the end surface film source 40 when the end surface film source 40 has been emptied.

In an embodiment, in order to allow the end surface film source support 32 to be shifted between the operative configuration and the dispensing configuration, the end surface film source support 32 is mounted to pivoting arms 31. The end surface film source support 32 is connected to the pivoting arms 31 at a distal end thereof and the pivoting arms 31 are pivotally mounted to the frame 20 at a proximal end thereof. In order to allow the pivoting arms 31 to pivot, the proximal end of the pivoting arm 31 may be connected to a hinge assembly which allows pivoting thereof and securing of the arms 31 in either one of the operative configuration and the dispensing configuration.

One skilled in the art will understand that, in an alternative embodiment (not shown), the end surface wrapping mechanism 30 can include a dispensing assembly in order to dispense end surface film 36 from the end surface film source 40 configured in the operative configuration. In such an embodiment, the end surface film source 40 need not be configured in the above described dispensing configuration in order to dispense end surface film 36 therefrom. However the end surface film source 40 may be configured in the above described dispensing configuration for replacement of the end surface film source 40. In such an alternative embodiment, the dispensing assembly may include a crank assembly operatively connected to the end surface film source support 32 containing a roll of end surface film 36 as end surface film source 40. In order to dispense end surface film 36 from the roll of end surface film 36, a crank of the crank assembly may be rotated to cause rotation of the roll of end surface film 36 and the consequent dispensing of end surface film 36 therefrom.

One skilled in the art will understand that event though the end surface film source 40 of the illustrated embodiment is a roll of rolled end surface film 36, in alternative embodiments, other types of sources for providing wrapping film could be provided.

Moreover, in the illustrated embodiment where the end surface film source 40 is a roll of rolled film, the film can be pre-cut in the roll, i.e. the film may have frangible connections between sections thereof. Therefore, in operation, when the tension imparted on a frangible connection exceeds a threshold tension, the length of end surface film 36 is separated from the end surface film source 40. Such a configuration allows the length of end surface film 36 to be separated from the roll, for example after a predefined length has been dispensed, as a result of the breaking of the frangible connection causing a separation between the roll and the length of end surface film 36. Regarding the separation between the length of end surface film 36 and the retaining assembly 33, in the illustrated embodiment, such a separation occurs as a result of tearing caused by the pressure exerted on the end surface film 36 by the movement of the bale 12 towards the discharging section 26.

One skilled in the art would understand that, in alternative embodiments (not shown), a cutting assembly (not shown) can be provided for cutting the film when required, the end surface film 36 may be manually cut by an operator proximate to the end surface film source 40 and/or the retaining assembly 33 or other components and/or mechanisms different from the ones of the illustrated embodiment, may be used to separate the end surface film 36 from the end surface film source 40 and/or the retaining assembly 33.

Now referring to FIGS. 1 to 6, as previously stated, a length 38 of end surface film 36 is dispensed from the end surface film source 40 and at least a portion of this length 38 of end surface film 36 is maintained across the bale wrapping section 24 in order to engage the end surface of a bale 12 displaced along the longitudinal moving axis 29. In the illustrated embodiment, the length 38 of end surface film 36 is manually dispensed from the end surface film source 40 and attached to the retaining assembly 33 when the end surface film source support 32 is configured in the dispensing configuration and is increased as the end surface film source support 32 is pivoted into the operative configuration.

The retaining assembly 33 includes attachment members 52 connected to the frame 20 for receiving and retaining a portion of the end surface film proximate to the distal end 54. Therefore, in the illustrated embodiment, the operator can pull the distal end 54 of the end surface film 36 from the end surface film source support 32, configured in the dispensing configuration, of a sufficient length 38 to reach the attachment members 52. Subsequently the distal end 54 of the end surface film 36 can be engaged into the attachment members 52 such that it is maintained in place and the end surface film source support 32 can subsequently be configured in the operative configuration.

In the illustrated embodiments, the attachment members 52 are positioned in the bale receiving section 22 of the frame 20. Such a positioning of the attachment members 52 ensures that a portion of the length 38 of end surface film 36 extends below the side surface 16 of the bale 12. Therefore, in an embodiment, a portion of the length 38 of the end surface film 36 may extend across the wrapping section 24 and a portion of the length 38 may extend in the receiving section 22, below the support supporting the bale in the bale receiving section 22.

One skilled in the art will understand that, even though the securing of the distal end 54 of the end surface film 36 to the attachment members 52 is described herein as being made manually by an operator, in an alternative embodiment, such securing could be automated. Indeed, in an alternative embodiment, the dispensing of the length 38 of end surface film 36 and subsequent securement of the distal end 54 thereof can be automated. Moreover, in an embodiment, the shift between the dispensing configuration and the operative configuration of the end surface film source support 32 could also be automated.

As can be seen in the illustrated embodiments, when a length 38 of end surface film 36 is dispensed, the end surface film 36 has a length 38 and a width 37 which cover more than the end surface 14 of the bale 12 and extend over the outer edges of the end surface 14. In other words, when the end surface 14 of the bale 12 engages the length 38 of end surface film 36, the length 38 of the end surface film 36 should extend beyond a periphery of the end surface 14 and expand into at least a section of the side surface 16 of the bale 12.

In an embodiment, end surface film guides are provided for guiding the length of end surface film 36 towards the side surface of the bale 12. In an embodiment, the end surface film guides includes an upper arch 56 positioned below the end surface film source support 32, and proximate thereto. In operation, the upper arch 56 guides a portion of the end surface film 36 downward, from above, towards the side surface 16 of the bale 12, when the end surface film source support 32 is configured in the operative configuration, such as to prevent the end surface film 36 to impede the action of the side surface wrapping mechanism, which will be described below. In an embodiment, the end surface film guides further includes lateral guides 57 positioned laterally along the longitudinal moving axis 29 of the transfer path. The lateral guides 57 are configured and positioned to guide a portion of the end surface film 36 towards the side surface 16 of the bale 12 laterally, thereby facilitating the subsequent dispensing of side surface wrapping along the side surface of the bale 12, as will be described below.

Now referring to FIGS. 1 to 4, the wrapping device 10 is further provided with a side surface wrapping mechanism 60 mounted to the base frame 20. The side surface wrapping mechanism 60 is positioned in the bale wrapping section 24, between the end surface wrapping mechanism 30 and the bale discharging section 26.

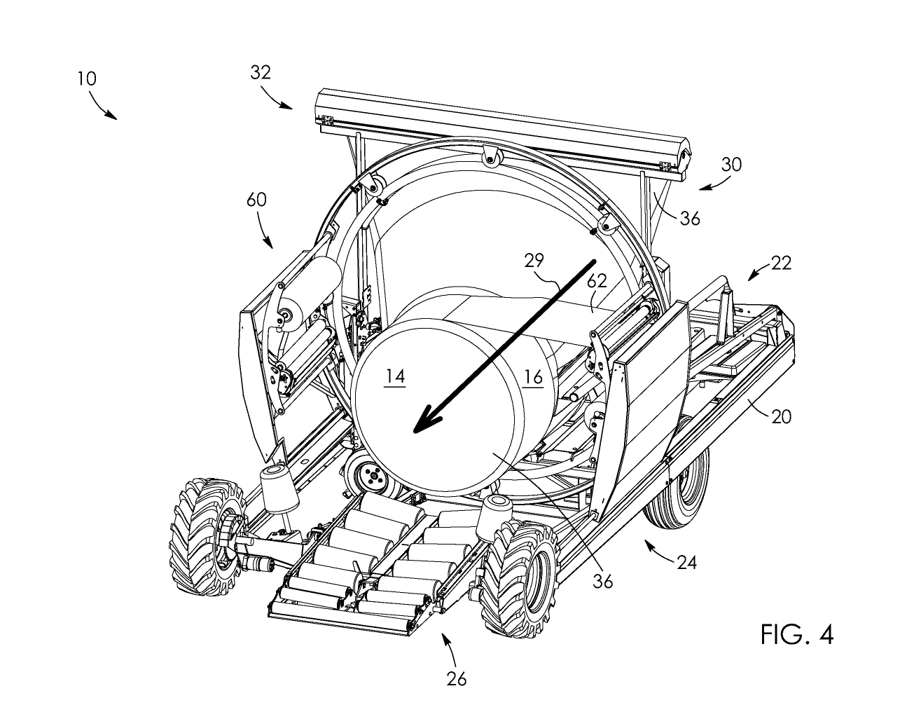

As can easily be seen in FIG. 4, the side surface wrapping mechanism 60 can dispense a length of side surface film 62 around at least a longitudinal portion of the side surface of the bale 12, thereby resulting in the sealing of the end surface 14 of the bale 12 by the end surface film 36. Indeed, in operation, when the bale 12 is moved into the wrapping section 24, the end surface 14 of the bale 12 engages the end surface film 36 positioned across the wrapping section 24. Given that the side surface wrapping mechanism 60 is positioned subsequently to the end surface wrapping mechanism 30, the side surface film 62 provided around the side surface 16 of the bale 12 is wrapped around the portion of end surface film exceeding the edges of the end surface 14 of the bale and maintains this exceeding portion against the side surface 16 thereof, thereby creating the desired sealing of the end surface 14 of the bale 12. One skilled in the art will understand that the side surface wrapping mechanism 60 may be used to cover the whole length of the side surface 16 of the bale 12 or only a portion of the longitudinal section of the side surface 16 of the bale 12 that is sufficient for maintaining the exceeding portion of end surface film 36 against the side surface 16.

One skilled in the art will understand that different side surface wrapping mechanisms 60 may be used to perform the desired wrapping of the side surface 16 by providing side surface film 62 around the side surface 16 thereof.

In an embodiment, the side surface wrapping mechanism 60 may comprise a fixed inner hoop 64, a rotatable outer hoop 66 connected to the outer surface of the inner hoop 64, at least one cantilevered support 68 mounted on the outer hoop 66 and a driving mechanism 69 operatively connected to the outer hoop 66 for rotating the outer hoop 66. In such an embodiment, the rotatable outer hoop 66 is rotatably connected to the outer surface of the inner hoop 64 and has a shape that matches that of the inner hoop 64 to allow the outer hoop 66 to maintain a proximal relationship with the outer surface of the inner hoop 64 during rotation. The cantilevered support 68 may include at least one spool holder 70 for rotatably mounting a spool of side surface film 62 thereon and a tensioning mechanism 72 for stretching the side surface wrapping film 62 before the film is wrapped around the side surface 16 of the bale 12. The driving mechanism 69 is operatively connected to the outer hoop 66 for rotating the outer hoop 66 and thereby drives the cantilevered support 68 around the bale 12 to dispense side surface film 62.

A non-limitative embodiment of a wrapping device that may be used as side wrapping mechanism is described in detail in the present Applicant's United States Patent Application No. 2012/0180430, which is incorporated herein by reference.

Another non-limitative embodiment of a device that may be used for the side wrapping mechanism is described in Canadian Patent Application No. 2,112,530, which is also incorporated herein by reference.

In view of the above, in order to perform the wrapping of an end surface and at least a portion of a side surface of at least one bale, using an inline bale wrapping device as described above, the following steps are performed. A bale longitudinally movable along transfer path, following a longitudinal axis, is received at a receiving end of the bale wrapping device. A length of end surface film is dispensed and maintained across the transfer path. As previously mentioned, the length of end surface film is sized and shaped to extend beyond a periphery of the end surface of the bale. The length of end surface film may be dispensed and maintained across the transfer path by configuring the end surface film source support in the dispensing configuration, pulling a length of end surface film from the end surface film source and engaging the end surface film to attachment members and configuring the end surface film source support in the operative configuration. The bale is subsequently moved longitudinally along the transfer path such as to engage its end surface with the end surface film and a side surface film is wrapped around a side surface of the bale, over a portion of the end surface film extending beyond the periphery of the end surface of the bale.

One skilled in the art will understand that the above described wrapping device 10 and method of operation described above are destined to seal one end surface of a bale. However, when sealing of a second end surface is desired, the bale can be inverted and wrapped a second time using the same wrapping device and method for sealing the opposed end surface.

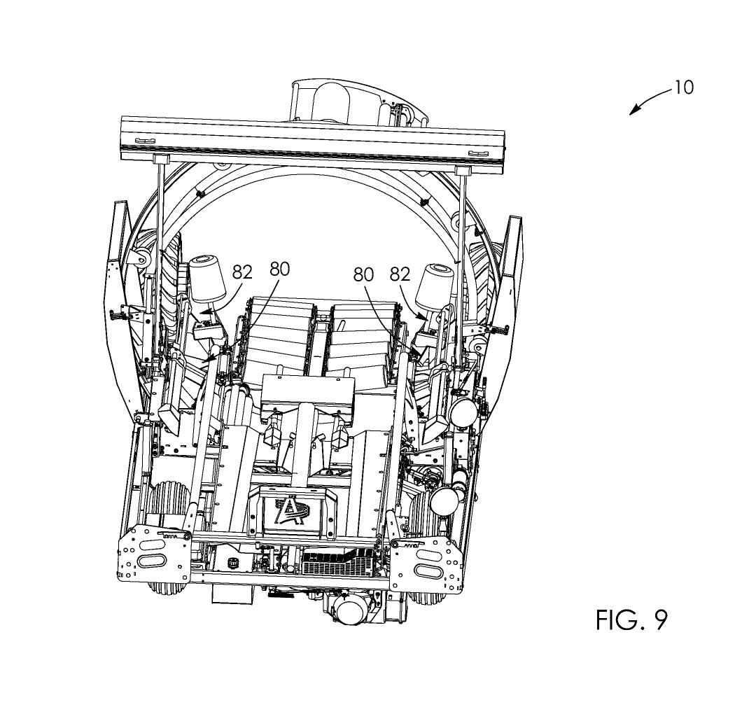

Now referring to FIGS. 9 to 11, in an embodiment, the wrapping device 10 may further include a side wrapping cutting mechanism 80 mounted to the frame 20. The side wrapping cutting mechanism 80 allows the cutting and holding of the side surface film 62, subsequently to the cutting operation.

In the illustrated embodiment, the side wrapping cutting mechanism 80 includes two extendable arms 82 formed of cutting shafts 82a, 82b and corresponding cutting assemblies 84. In an embodiment, the extendable arms 82 are operated simultaneously to sever the side surface film between the source and the bale 12. One skilled in the art will understand the amount of arms 82 and corresponding cutting assemblies 84 may be varied to operate with different side surface wrapping mechanisms 60. Moreover it will be understood that in alternative embodiments, the arms 82 and corresponding cutting assemblies 84 may be operated independently.

One skilled in the art will also understand that the term “extendable arm” is used herein to refer to a component which can be extended and retracted and that in different embodiments, different components or assembly resulting in longitudinal movement and capable of pulling a section of side surface film 62, when retracted, as will be described in more details below, could be used. Moreover, in the illustrated embodiment, each retractable arm 82 is composed of three extendable shafts 82a, 82b, but one skilled in the art will understand that a different amount of cooperating shafts may be used.

Since the operation of each arm 82, along with the corresponding cutting assembly 84 is similar, the operation of one of the arm 82 will be described below. However, one skilled in the art will understand that more than one arm 82 may operate concurrently, similarly to what is described below.

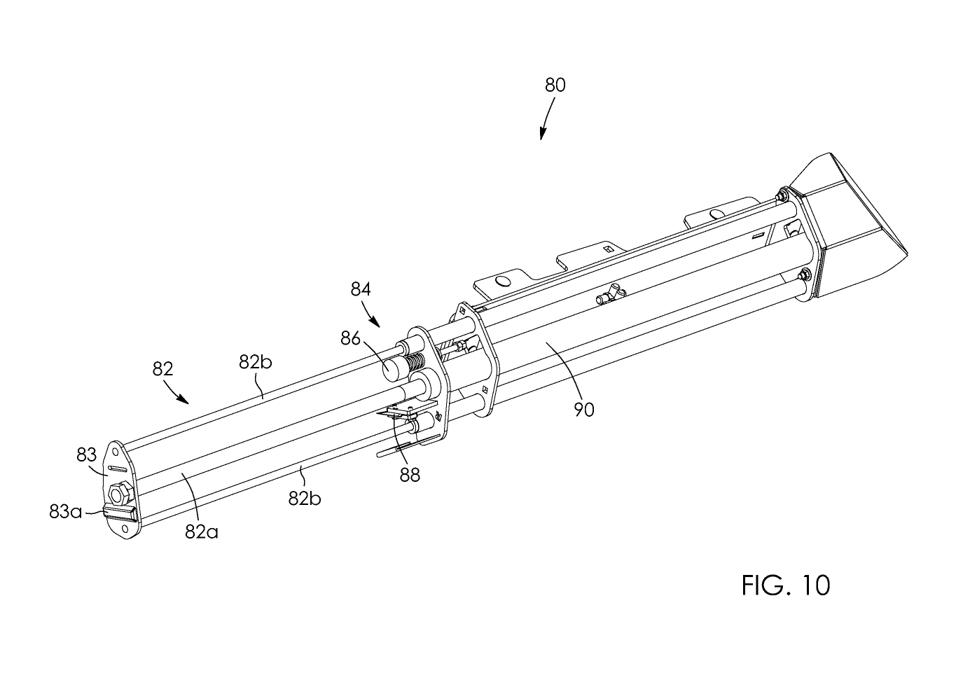

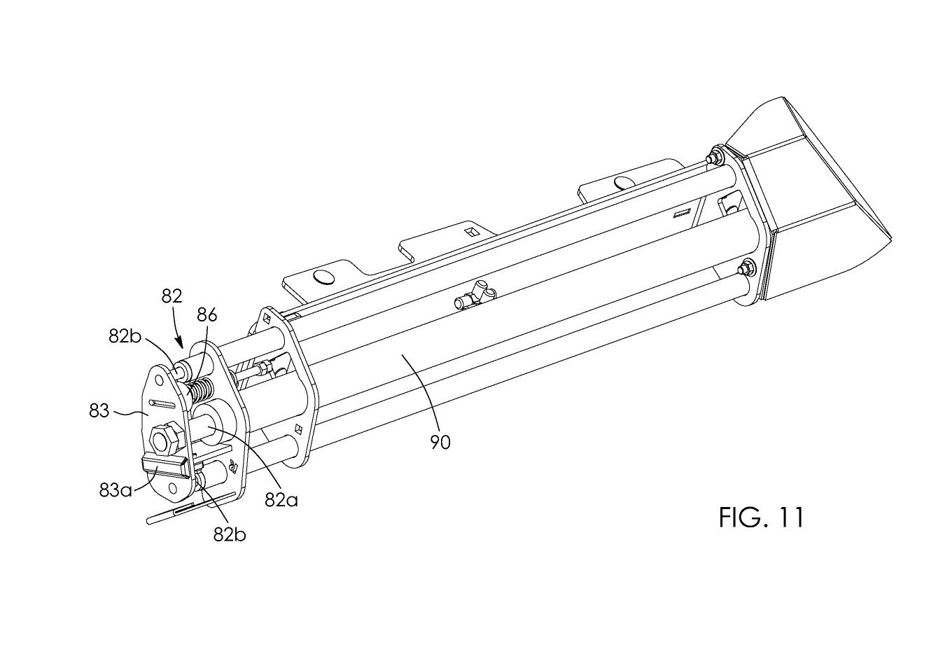

The extendable arm 82 has an abutment member 83 at a first end thereof and is configurable between an extended configuration (shown in FIGS. 9 and 10) and a retracted configuration (shown in FIG. 11). In an embodiment, the extendable arm 82 is composed of a central shaft 82a extending from a hydraulic cylinder 90 and lateral shafts 82b. However, one skilled in the art will understand that, in alternative embodiments, other types of mechanisms for providing an extendable arm could be used. For example and without being !imitative, a pneumatic cylinder may be used instead of a hydraulic cylinder. The cutting assembly 84 also includes a resilient member 86 and a fixed blade 88.

When the extendable arm 82 is configured in the extended configuration (shown in FIGS. 9 and 10), the extendable arm 82 extends away from the cutting assembly 84, i.e. the abutment member 83 of the extendable arm 82 is spaced apart from the cutting assembly 84. In such a configuration, the arm 82 extends at least over a length sufficient for the abutment member 83 to be past the side surface film that is dispensed by the side surface wrapping mechanism 60. In other words, the arm 82 must extend longitudinally of a distance greater than the width of the side surface film 62 dispensed by the side surface wrapping mechanism 60.

Now referring to FIG. 11, when the extendable arm 82 is configured in the retracted configuration, the abutment member reaches the fixed blade 88, and is further retracted such that the front end of the fixed blade enters a receiving cavity 83a formed therein and the abutment member 83 is pressed against the resilient member 86 of the cutting assembly 84.

In an alternative embodiment (not shown), the resilient member may be provided between the fixed blade and the abutment member of the arm. Therefore when the extendable arm is configured in the retracted configuration, the abutment member is pressed against the resilient member of the cutting assembly and can subsequently be further retracted to contract the resilient member until the abutment member reaches the fixed blade.

Using the side wrapping cutting mechanism 80 of the illustrated embodiment, in operation, the following steps are provided for each extendable arm and corresponding cutting assembly, for cutting the side surface film 62. Firstly, a length of side surface wrapping film 62 is dispensed around the bale 12 by the side surface film wrapping mechanism 60, while the extendable arm 82 is maintained in the retracted configuration. Subsequently, the extendable arm 82 is configured in the extended configuration and extends proximate to the side surface 16 of the bale 12. As previously stated, the extendable arm 82 extends at least over a length sufficient for the abutment member 83 to be past the extremity of the side surface film 62 that is distal from the cutting assembly 84, thereby spanning at least the width of the side surface wrapping film 62. Once the extendable arm 82 is configured in the extended configuration, an additional length of side surface wrapping film 62 is dispensed around the side surface 16 of the bale 12, using the side surface film wrapping mechanism 60. Given the position of the extended extendable arm 82, the dispensing of the additional length of side surface film 62 results in the side surface film 62 being wrapped over the extendable arm 82. Subsequently, the extendable arm 82 is retracted towards the cutting assembly 84, in the retracted configuration. The retraction of the extendable arm 82 causes the section of side surface film 62 which extends over the cutting shaft 82 to be pulled towards the blade 88 and resilient member 86 of the cutting assembly 84 and to be substantially simultaneously sandwiched between the abutment member 83 and the resilient member 86 and cut by the cutting blade 88. Consequently, the side surface film 62 can be cut and the section of side surface film is still held between the resilient member 86 and the abutment member 83. One skilled in the art will understand that the position of the blade 88 with regards to the resilient member 86 is configured to sever the side surface film 62 at a location that allows the portion of film attached to the bale to be released and the section of film that is attached to the film source to be maintained between the abutment member 83 and the resilient member 86.

In the alternative embodiment (not shown) where the resilient member is provided between the fixed blade and the abutment member of the arm, further retraction of the arm 82 is required to cause the resilient member 86 to be contracted until the section of side surface film 62 is severed against the blade 88 located behind the resilient member 86.

It will be understood that, in alternative embodiments, different components or assemblies resulting in a longitudinal movement of a component along the side surface of the bale and capable of pulling a section of side surface film towards a cutting assembly, where the side surface film is cut and a section is released while another section of side surface film is maintained thereon, could be used. One skilled in the art will understand that accordingly, the steps of a corresponding method of operation could also differ from the one described above.

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. An inline bale wrapping device for wrapping at least one bale having an end surface and a side surface, the wrapping device comprising:
a base frame defining a bale receiving section, a bale discharging section and a bale wrapping section, the bale wrapping section being positioned between the bale receiving section and the bale discharging section of the base frame;
a moving mechanism configured to move the at least one bale longitudinally along a longitudinal moving axis, between the bale receiving section and the bale discharging section of the base frame;
an end surface wrapping mechanism connected to the base frame, in the bale wrapping section, the end surface wrapping mechanism being configured to dispense and maintain a length of end surface film across the longitudinal moving axis and to apply a tension to the length of end surface film, the length of end surface film being maintained substantially perpendicular with respect to the longitudinal moving axis prior to an engagement of the length of end surface film with the at least one bale, and being sized and shaped to extend beyond a periphery of the end surface of the at least one bale; and
a side surface wrapping mechanism mounted to the base frame, in the bale wrapping section, between the end surface wrapping mechanism and the bale discharging section, the side surface wrapping mechanism being configured to dispense a length of side surface film and wrapping the length of side surface film around at least a longitudinal portion of the side surface of the bale, over a portion of the length of end surface film.

2. The inline bale wrapping device of claim 1, wherein the end surface wrapping mechanism comprises an end surface film source support, the end surface film source support being configurable in an operative configuration and a dispensing configuration.

3. The inline bale wrapping device of claim 2, wherein when the end surface film source support is configured in the operative configuration, the end surface film source support is positioned above the wrapping section of the base frame at a distance sufficient for the at least one bale to be moved between the frame and the end surface film source support.

4. The inline bale wrapping device of claim 2, wherein when the end surface film source support is configured in the dispensing configuration, the end surface film source support is positioned proximate to the base frame such as to be accessible to an operator standing on the ground.

5. The inline bale wrapping device of claim 2, wherein the end surface film source support is mounted to pivoting arms, the pivoting arms being pivotally mounted to the frame and being configured to shift the end surface film source support between the operative configuration and the dispensing configuration upon pivoting thereof.

6. The inline bale wrapping device of claim 1, further comprising at least one end surface film guide configured to guide a section of the length of end surface film towards the side surface of the at least one bale.

7. The inline bale wrapping device of claim 6, wherein the at least one end surface film guide comprises an upper arch configured to guide a section of the length of end surface film towards the side surface of the at least one bale, from above.

8. The inline bale wrapping device of claim 6, wherein the at least one end surface film guide comprises at least one lateral guide positioned laterally along the longitudinal moving axis and being configured to guide a section of the end surface film towards the side surface of the at least one bale laterally.

9. The inline bale wrapping device of claim 1, further comprising a side wrapping cutting mechanism comprising:
at least one cutting assembly with a resilient member and a blade; and
at least one corresponding extendable arm having an abutment member at a first end thereof and being configurable between an extended configuration, wherein the first end is spaced apart from the corresponding cutting assembly, and a retracted configuration, wherein the abutment member is pressed against the resilient member of the corresponding cutting assembly.

10. A method for wrapping an end surface and at least a portion of a side surface of at least one bale using an inline bale wrapping device, the method comprising the steps of:
receiving at least one bale in a receiving section of the bale wrapping device, the at least one bale being movable longitudinally along a transfer path following a longitudinal axis;
dispensing and maintaining a length of end surface film across the transfer path with a tension therein, the length of end surface film being maintained substantially perpendicular with respect to the longitudinal moving axis prior to an engagement of the length of end surface film with the at least one bale, and being sized and shaped to extend beyond a periphery of the end surface of the at least one bale;
moving the at least one bale longitudinally along the transfer path such as to engage the end surface of the at least one bale with the end surface film; and
wrapping a side surface film around a side surface of the at least one bale, over a portion of the end surface film extending beyond the periphery of the end surface of the at least one bale.

11. The method of claim 10, wherein the step of dispensing and maintaining a length of end surface film across the transfer path includes the steps of:
configuring an end surface film source support in a dispensing configuration;
pulling a length of end surface film from an end surface film source and engaging the end surface film to at least one attachment member; and
configuring the end surface film source support in an operative configuration.

12. The method of claim 10, further comprising the step of severing the end surface film and the side surface film.

13. The method of claim 10, further comprising the step of cutting and holding a side surface film having a width, using at least one extendable arm with an abutment member at a first end and a corresponding cutting assembly with a resilient member and a blade.

14. The method of claim 13, wherein the step of cutting and holding a side surface film comprises the steps of:
extending the at least one extendable arm proximate to the side surface of the at least one bale, the at least one extendable arm spanning at least the width of the side surface film;
dispensing an additional length of side surface film around the side surface of the at least one bale, the additional length extending over the at least one extendable arm;
retracting the at least one extendable arm towards the corresponding cutting assembly, the retraction of the extendable arm causing a section of the side surface film to be held between the abutment member and the resilient member and another section of the side surface film to be severed against the blade.
